(19) United States
(12) Patent Application Publication
(10) Pub. No.: US 2001/0044302 A1
(43) Pub. Date: Nov. 22, 2001

(54) Portable telephone terminal device and portable telephone system using the same

(75) Inventor: Toshiyuki Okuyama, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/858,767

(22) Filed: May 16, 2001

(30) Foreign Application Priority Data
May 17, 2000 (JP) 144237/2000

(51) Int. Cl. H04Q 7/20

(52) U.S. Cl. 455/432; 455/414

(57) ABSTRACT

For reporting an emergency at a minimal level if a user enters the emergency and requires a help of a third party, a portable telephone terminal device receives reported information “S1” constantly transmitted from a radio base station in a country and a district in which the user is roaming, and obtains basic information for use in the communications with the radio base station. The portable telephone terminal device transmits the information about its own station to the radio base station to perform location registration “S2”. The portable telephone terminal device transmits contract area identification information “S3”, and reports corresponding function presence/absence information “S4”. The radio base station transmits to the portable telephone terminal device the information about emergency telephone numbers “S5” of the nearest medical facilities, or the like and formatted text “S6” in the local official language for use in reporting an emergency to the facilities, or the like in either voice or characters. The portable telephone terminal device receives the emergency telephone numbers “S5” and the formatted text “S6”, stores them in a storage unit, and enters a wait state.

### BACKGROUND OF THE INVENTION

1. Field of the Invention

The present invention relates to a portable telephone terminal device and a portable telephone system using the same, and more specifically to an international roaming service, or the like for receiving a service away from a country (district) in which a user has made a contract for the service.

2. Description of the Prior Art

Conventionally, in a radio telephone (portable telephone) system (mobile communication system) in which a ground mobile station establishes communications through a relay station, there are usually variations of systems available for enterprises (service providers).

The mobile station issues a request to register its position (location) to the relay station of an enterprise system to which the mobile station subscribes. When the mobile station is out of the communications area of the enterprise system and enters the communications area of another enterprise system, the mobile station registers its position to the relay station of the other enterprise system so that the mobile station can receive a service in the communications area of the other enterprise system, which is referred to as a roaming service.

Portable telephones have proceeded with the international standardization in the communications system, and a user can receive a service when the user leaves the country (district) in which the user has made a contract for an international roaming service, or the like.

However, when the user establishes emergency communications in the country or the district in which the user is roaming, the user may not be familiar to the local official language, or the emergency telephone numbers of a police station, a fire department, or the like depend on each district. Furthermore, with the emotional state of the user encountering an emergency in a foreign country taken into account, establishing emergency communications is very difficult for the user.

### SUMMARY OF THE INVENTION

The present invention has been developed to solve the above mentioned problems, and aims at providing a portable telephone terminal device and a portable telephone system capable of making the emergency report at the minimal level when the user encounters the emergency and requires the help of someone else.

A portable telephone terminal device according to the present invention has a function of receiving an international roaming service for receiving a service in a country or a district when a user is away from a country and a district in which the user has made a contract for the service. It includes storage means for storing information about telephone numbers of at least a police station, a fire department, an embassy, and medical facilities in a country or a district in which the user is roaming, and information in a formatted text in a local official language in at least one of voice and characters which is used in emergency communication.

A portable telephone system according to the present invention includes: a portable telephone terminal device having a function of receiving an international roaming service for receiving a service in a country or a district when a user is away from a country or a district in which the user has made a contract for the service; and a radio base station for providing the service for the portable telephone terminal device.

The portable telephone terminal device includes storage means for storing information about telephone numbers of at least a police station, a fire department, an embassy, and medical facilities in a country or a district in which the user is roaming, and information in a formatted text in a local official language in at least one of voice and characters which is used in emergency communication.

The radio base station includes transmission means for transmitting at least the information about the telephone numbers to the portable telephone terminal device.

That is, the portable telephone terminal device according to the present invention provides the function and service of a portable telephone to easily make a report especially in the emergency communications when the user uses the portable telephone while covering different districts in official language and customs by the internationally roaming service.

When the portable telephone terminal user uses the international roaming service away from the country (district) in which the user has made the contract for the service, the information about the emergency telephone numbers of the police station, the fire department, or the like in the country (district) and the information in the formatted text in voice or characters to be used in the emergency communications in an in-side official language are automatically obtained from the service provider in the country and the district in which the user is roaming when the initial location is registered in the country or the district in which the user is roaming, and stored in the portable telephone terminal, or the type of the local official language is obtained, and the information available in the district is selected from the information in the formatted information in voice or characters in some languages stored in the portable telephone terminal in advance.

When the user actually encounters the emergency, the user retrieves the above mentioned information in a simple operation, and establishes the emergency communications, thereby contents of appropriate communications are transimitted. In addition, without making a call, the third party who happens to be present at the site can be notified of the emergency by producing the above mentioned voice from the speaker included in the portable telephone terminal, or displaying the above mentioned formatted text on the character display unit included in the portable telephone terminal. Furthermore, if the portable telephone terminal corresponds to a position information system, the current position can be reported when the emergency communications are established.

### BRIEF DESCRIPTION OF THE DRAWINGS

FIG. 1 is a block diagram showing the configuration of a portable telephone terminal device according to an embodiment of the present invention; and

FIG. 2 is a sequence chart showing the procedure of the portable telephone terminal device shown in FIG. 1 when receiving a service from a radio base station in the country (district) in which the user is roaming.

### DETAILED DESCRIPTION OF THE PREFERRED EMBODIMENTS

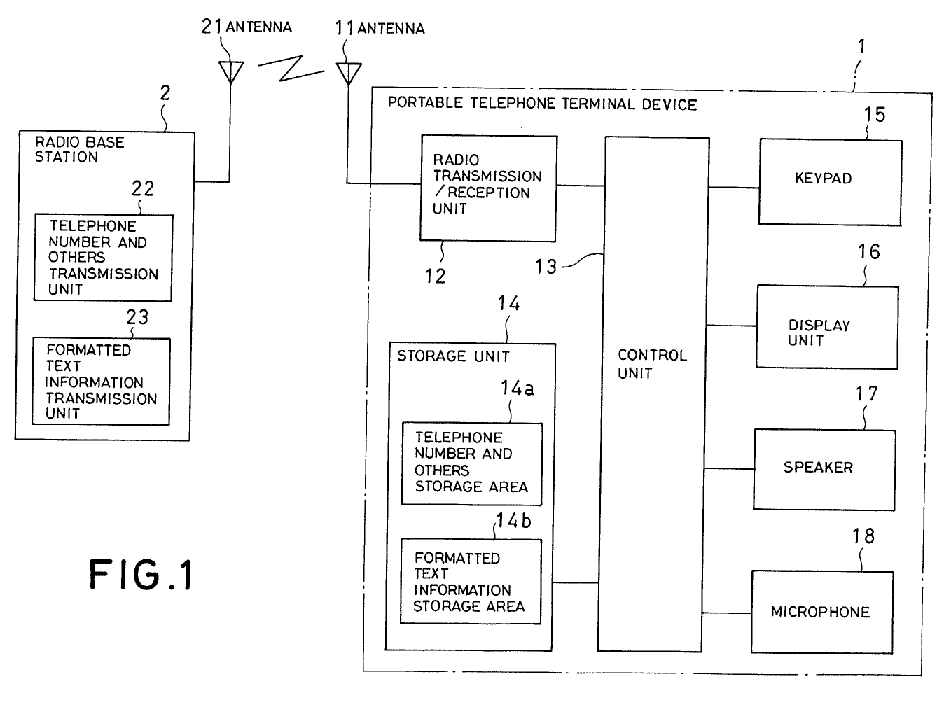

The embodiment of the present invention will be described below with reference to the drawings. FIG. 1 is a block diagram showing the configuration of a portable telephone terminal device according to an embodiment of the present invention. In FIG. 1, a portable telephone terminal device 1 comprises an antenna 11, a radio transmission/reception unit 12, a control unit 13, a storage unit 14, a keypad 15, a display unit 16, a speaker 17, and a microphone 18.

The radio transmission/reception unit 12 transmits/receives voice or data with a radio base station 2 through the antenna 11, a radio medium not shown in FIG.1, and an antenna 21 of the radio base station 2. The radio base station 2 comprises a telephone number and others transmission unit 22 and a formatted text information transmission unit 23.

The control unit 13 interconnects the blocks in the portable telephone terminal device 1, and controls the flow of data and signals, and operations of each block. The storage unit 14 is used as storage means by the control unit 13, and comprises a telephone number and others storage area 14a and a formatted text information storage area 14b.

The keypad 15 is used by the user operating the portable telephone terminal device 1. The display unit 16 displays characters and graphics information received or generated by the portable telephone terminal device 1. The speaker 17 outputs voice received or generated by the portable telephone terminal device 1. The microphone 18 is used for transmitting the voice of the user.

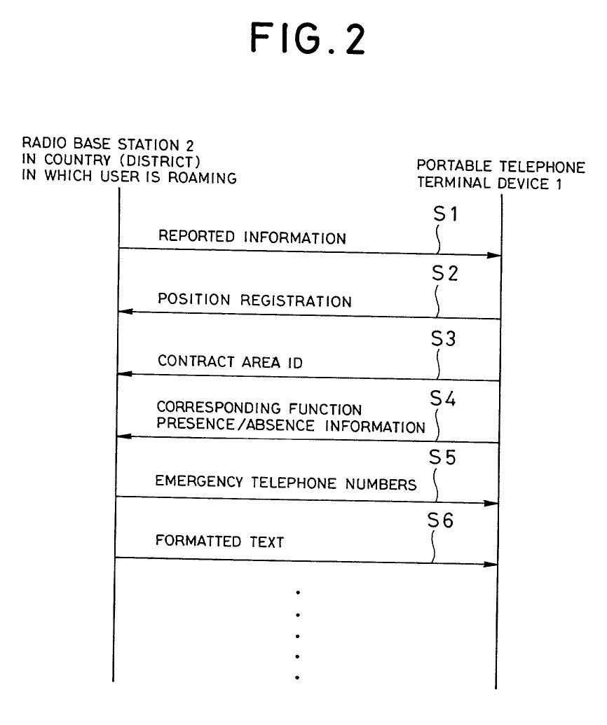

FIG. 2 is a sequence chart showing the procedure of the portable telephone terminal device 1 shown in FIG. 1 when receiving the service from the radio base station 2 in the country (district) in which the user is roaming. In FIG. 2, arrows indicate the communications between the portable telephone terminal device 1 and the radio base station 2, and the directions of the arrows indicate the direction of the communications.

The communications between the portable telephone terminal device 1 and the radio base station 2 are performed through the radio medium between the antenna 11 of the portable telephone terminal device 1 and the antenna 21 of the radio base station 2, and the actual communications are performed by the radio transmission/reception unit 12 in the side of the portable telephone terminal device 1.

When the portable telephone terminal device 1 receives data and signals, the radio transmission/reception unit 12 retrieves significant data or signals for the portable telephone terminal device 1 from the received signal, and the retrieved data and signals are transmitted by the control unit 13 to the display unit 16 and the speaker 17, and then transmitted to the user, used as control information for control of the control unit 13, or stored in the storage unit 14.

When the portable telephone terminal device 1 transmits data and signals, the data and signals provided by the user through the keypad 15 and the microphone 18, the data stored in the storage unit 14, or the data generated by the control unit 13 are transmitted by the control unit 13 to the radio transmission/reception unit 12, and then converted into a radio signal and transmitted through the antenna 11 and the radio medium.

First, the portable telephone terminal device 1 receives reported information “S1” constantly transmitted from the radio base station 2 in the country and the district in which the user is roaming, and obtains basic information for communications with the radio base station 2. Then, the portable telephone terminal device 1 transmits the information about its own device to the radio base station 2 to perform location registration “S2”.

At this time, to utilize the service according to the present invention, the portable telephone terminal device 1 transmits contract area identification information (contract area ID) “S3” by which the radio base station 2 can determine which official language and emergency telephone numbers are used in the area where the roaming connection is made to the station. Then, the portable telephone terminal device 1 transmits corresponding function presence/absence information “S4” indicating that its own device has the function of receiving the service.

Then, the radio base station 2 determines according to the contract area identification information “S3” and the corresponding function presence/absence information “S4” transmitted from the portable telephone terminal device 1 that the roaming connection is made from the area in which a different official language and emergency telephone numbers are used, and also determines that the portable telephone terminal device 1 has the function of receiving the current service. Then the radio base station 2 starts providing the service.

The radio base station 2 transmits emergency telephone numbers “S5”, which comprise the emergency telephone numbers of the police station, the fire department, or the like used on the site and the telephone numbers of the embassy or the like corresponding to the comtract area identification information “S3” transmitted from the portable telephone terminal device 1, from telephone number and others transmittion unit 22 to the portable telephone terminal device 1. If the radio base station 2 stores the position information about the portable telephone terminal device 1, the emergency telephone numbers “S5” have telephone numbers of the nearest medical facilities or the like. And the radio base station 2 transmits the formatted text “S6” in the local official language used in reporting to the above mentioned stations and faclities from the formatted text information transmission unit 23 as the voice or character information to the portable telephone terminal device 1.

The teleportable telephone terminal device 1 receives the above mentioned emergency telephone numbers “S5 ” and formatted text “S6”, and stores them in the telephone number and others storage area 14a and the formatted text information storage area 14b of the storage unit 14, and enters a wait state (an idle mode).

When the user actually enters the emergency, he or she operates the keypad 15 of the portable telephone terminal device 1 to call up the formatted text “S6” corresponding to the emergency from the storage unit 14. If there is a third party to be asked to help the user, then the called formatted text “S6” is displayed as character information on the display unit 16, or it is output as voice from the speaker 17 to notify the emergency to the third party.

If there is nobody to be asked to help the user, the formatted text S6 is called and then a calling operation is performed to call up a facility which can address the emergency, the formatted text S6 is transmitted as voice or character information, thereby informing the facility that the user who is not familiar to the local official language has entered the emergency.

If the portable telephone terminal device 1 corresponds to a position information system not shown in the attached drawings, it can be notified of the current position upon the emergency communications. The position information system roughly specifies the current position of the mobile communications terminal of the portable telephone terminal device 1, or the like, and provides the position information for the user.

Thus, when the user of the portable telephone terminal device 1 receives the roaming service away from the country (district) in which the user has made the contract for the international roaming service, or the like, the user can use the emergency telephone numbers “S5” and the formatted text “S6” obtained and stored in the portable telephone terminal device 1 in a simple operation, and report the emergency at the minimal level by automatically obtaining and storing in the portable telephone terminal device 1 for use in the roaming service the local emergency telephone numbers “S5” and the formatted text “S6” in the local official language available in the emergency in case the user enters the emergency and requires the help of the third party without knowing the emergency telephone numbers of the police station, the fire department, or the like and without knowing the local official language.

As described above, according to the present invention, with the portable telephone terminal device having the function of receiving the international roaming service for receiving the service in a country and a district away from the country and the district in which the user has made the contract for receiving the service, the user can report the emergency at the minimal level in case the user enters the emergency and requires the help of the third party by providing storage means for storing the information about the telephone numbers of at least the police station, the fire department, the embassy, and the medical facilities in the country and the district in which the user is roaming, and the information in the formatted text in at least one of voice and characters for use in the emergency communications in the local official language.

What is claimed is:

1. A portable telephone terminal device having a function of receiving an international roaming service for receiving a service in a country or a district when a user is away from a country and a district in which the user has made a contract for the service, comprising
storage means for storing information about telephone numbers of at least a police station, a fire department, an embassy, and medical facilities in a country or a district in which the user is roaming, and information in a formatted text in a local official language in at least one of voice and characters which is used in emergency communication.

2. The portable telephone terminal device according to claim 1, further comprising
means for obtaining said information about the telephone numbers and said information in the formatted text from a service provider in the country or the district in which the user is roaming at least when an initial location is registered in the country or the district in which the user is roaming,
wherein said information about the telephone numbers and said information in the formatted text obtained from said service provider are stored in said storage means.

3. The portable telephone terminal device according to claim 1, further comprising
means for automatically obtaining said information about the telephone numbers and a type of said local official language from a service provider in the country or the district in which the user is roaming at least when an initial location is registered in the country and the district in which the user is roaming,
wherein the information available in the district is selected from said the information in the formatted text stored in said storage means in advance.

4. The portable telephone terminal device according to claim 1,
wherein said information in the formatted text is transmitted by issuing a call according to said information about the telephone numbers depending on a predetermined key operation.

5. The portable telephone terminal device according to claim 1, further comprising
means for notifying a third party of said information in the formatted text depending on a predetermined key operation.

6. The portable telephone terminal device according to claim 5,
wherein said means for notifying the third party of the information notifies said information in the formatted text in voice.

7. The portable telephone terminal device according to claim 5, wherein
said means for notifying the third party of the information notifies said information in the formatted text as character information.

8. The portable telephone terminal device according to claim 1, further comprising
means for outputting position information in said emergency communication from a position information system for providing the position information by specifying a rough current position of a mobile communications terminal.

9. A portable telephone system, comprising:
a portable telephone terminal device having a function of receiving an international roaming service for receiving a service in a country or a district when a user is away from a country and a district in which the user has made a contract for the service; and
a radio base station for providing the service for said portable telephone terminal device,
wherein said portable telephone terminal device comprises storage means for storing information about telephone numbers of at least a police station, a fire department, an embassy, and medical facilities in a country and a district in which the user is roaming, and information in a formatted text in a local official language in at least one of voice and characters which is used in emergency communication, and
said radio base station comprises transmission means for transmitting at least said information about the telephone numbers to said portable telephone terminal device.

10. The portable telephone system according to claim 9,
wherein said transmission means is designed to transmit said information about the telephone numbers and said information in the formatted text at least when an initial location is registered in the country or the district in which the user is roaming; and
said storage means to store the transmitted information about the telephone numbers and the transmitted information in the formatted text in said portable telephone terminal device.

11. The portable telephone system according to claim 9,
wherein said information about the telephone numbers corresponding to position information about said portable telephone terminal device is transmitted when the position information is obtained.

12. The portable telephone system according to claim 11,
wherein said portable telephone terminal device comprises means for automatically obtaining said information about the telephone numbers and a type of said local official language from a service provider in the country or the district in which the user is roaming at least when an initial location is registered in the country or the district in which the user is roaming, and
said portable telephone terminal device selects the information available in the district from said information in the formatted text stored in said storage means.

13. The portable telephone system according to claim 9,
wherein said portable telephone terminal device transmits said information in the formatted text by issuing a call according to said information about the telephone numbers depending on a predetermined key operation.

14. The portable telephone system according to claim 9,
wherein said portable telephone terminal device comprises means for notifying a third party of said information in the formatted text depending on a predetermined key operation.

15. The portable telephone system according to claim 14,
wherein said means for notifying the third party of the information notifies said information in the formatted text in voice.

16. The portable telephone system according to claim 14,
wherein said means for notifying the third party of the information notifies said information in the formatted text as character information.

17. The portable telephone system according to claim 9,
wherein said portable telephone terminal device comprises means for outputting position information in said emergency communications from a position information system for providing the position information by specifying a rough current position of a mobile communications terminal.
